(19) United States
(12) Patent Application Publication
(10) Pub. No.: US 2021/0025430 A1
(43) Pub. Date: Jan. 28, 2021

(54) DUMBBELL-SHAPED ASYMMETRIC BIDIRECTIONAL TAPERED THREAD CONNECTION PAIR HAVING LAGER LEFT TAPER AND SMALL RIGHT TAPER

(71) Applicant: AMICUS VERITATIS MACHINERY CO., LTD., Taizhou (CN)

(72) Inventor: Yihua YOU, TAIZHOU (CN)

(21) Appl. No.: 17/036,030

(22) Filed: Sep. 29, 2020

Related U.S. Application Data
(63) Continuation of application No. PCT/CN2019/081389, filed on Apr. 4, 2019.

(30) Foreign Application Priority Data
Apr. 7, 2019 (CN) 201810303106.7

(51) Int. Cl. F16B 35/04

(52) U.S. Cl. CPC F16B 35/041

(57) ABSTRACT

Disclosed is a dumbbell-shaped asymmetric bidirectional tapered thread connection pair having lager left taper and a small right taper. The internal thread (6) of the thread connection pair (10) is a bidirectional taper hole (41) on the inner surface of a cylindrical base body (2) and external thread (9) is a bidirectional truncated cone body (71) on the outer surface of a columnar base body (3). Complete unit body threads are both helical, dumbbell-shaped (94), special bidirectional cone bodies each having a lager left taper (95) than right taper (96) and being small in the middle and large at both ends. The performance mainly depends on the conical surfaces and the tapers of the threaded bodies matching with each other.

### CROSS-REFERENCE TO RELATED APPLICATIONS

This application is a continuation of International Patent Application No. PCT/CN2019/081389, filed on Apr. 4, 2019, entitled “DUMBBELL-SHAPED ASYMMETRIC BIDIRECTIONAL TAPERED THREAD CONNECTION PAIR HAVING LAGER LEFT TAPER AND SMALL RIGHT TAPER,” which claims priority to China Patent Application No. 201810303106.7, filed on Apr. 7, 2018. The content of these identified applications are hereby incorporated by references.

### TECHNICAL FIELD

The disclosure relates to the technical field of general technology of devices, and more specifically to a dumbbell-shaped asymmetric bidirectional tapered thread connection pair having lager left taper and small right taper, or namely, dumbbell like (the left side taper is greater than the right side taper) asymmetric bidirectional tapered thread connection pair (hereinafter referred to as “dumbbell-shaped asymmetric bidirectional tapered thread connection pair”).

### BACKGROUND

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same thread profile and continuously protruding along a helical line on a cylindrical or conical surface; and the “thread body” refers to a material entity between adjacent flanks. This is also the definition of thread under global consensus.

The modern thread began in 1841 with British Whitworth thread. According to the theory of modern thread technology, the basic condition for self-locking of the thread is that an equivalent friction angle shall not be smaller than a helical rise angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder; and the flatter the inclined plane is, the greater the mechanical advantage is (see FIG. 8) (Jingshan Yang and Xiuya Wang, Discussion on the Principle of Screws, Disquisitiones Arithmehcae of Gauss).

The “principle of inclined plane” of the modern thread is an inclined plane slider model (see FIG. 9) which is established based on the law of inclined plane. It is believed that the thread pair meets the requirements of self-locking when a thread rise angle is less than or equal to the equivalent friction angle under the condition of little change of static load and temperature. The thread rise angle (see FIG. 10), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

The modern threads are abundant in types and forms, and are all tooth-shaped threads, which are determined by the technical principle, i.e., the principle of inclined plane. Specifically, the thread formed on a cylindrical surface is called cylindrical thread; the thread formed on a conical surface is called conical thread; and the thread formed on an end surface of the cylinder or the truncated cone is called plane thread. The thread formed on the surface of an outer circle of the body is called external thread; the thread formed on the surface of an inner round hole of the body is called internal thread; and the thread formed on the end surface of the body is called end face thread. The thread that the helical direction and the thread rise angle direction conform to the left-hand rule is called left-hand thread; and the thread that the helical direction and the thread rise angle direction conform to the right-hand rule is called right-hand thread. The thread having only one helical line in the same cross section of the body is called single-start thread; the thread having two helical lines is called double-start thread; and the thread having multiple helical lines is called multi-start thread. The thread having a triangular cross section is called triangular thread; the thread having a trapezoidal cross section is called trapezoidal thread; the thread having a rectangular cross section is called rectangular thread; and the thread having a zigzag cross section is called zigzag thread.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY

Any technical theory has a background of theoretical assumptions and of course, the thread has no exception. With technological improvements, the damage to the connection has been neither pure linear load nor static load nor room temperature. There are linear loads, nonlinear loads and even more complex failure loads when they are superimposed. The working condition is complicated. Based on this illusion, the purpose of this invention is to provide a dumbbell-shaped asymmetric bidirectional tapered thread connection pair to solve above problems, which has the advantage of reasonable design, simple structure, good connection performance, locking performance.

To achieve the above purposes, the invention adopts the following technical proposals: the dumbbell-shaped (left taper is greater than the right one) asymmetric bidirectional tapered thread connection pair is made up of asymmetric bidirectional tapered external thread and asymmetric bidirectional tapered internal thread. The invention relates to a special thread pair technology which combines the characteristics of cone pair and spiral motion technique. The above bidirectional tapered thread is a kind of screw thread technology which synthesizes the technical characteristics of bidirectional tapered body and spiral structure. The above bidirectional tapered body is composed of two single tapered bodies. In other words, it is composed of two tapered bodies whose left taper and right taper are opposite and different and whose left taper is greater than that of the right taper. The above bidirectional tapered body is spirally distributed on the outer surface of the cylindrical base body to form an external thread and/or the bidirectional tapered body is spirally distributed on the inner surface of the cylindrical base body to form an internal thread. Whatever internal or external threads, its complete unit thread is dumbbell-shaped special bidirectional tapered geometry with smaller middle and larger ends, and larger left taper than right taper.

The dumbbell-shaped asymmetric bidirectional tapered thread connection pair, and the definition of subject dumbbell-shaped asymmetric bidirectional tapered thread can be described as an asymmetric bidirectional taper hole (or an asymmetric bidirectional cone body) on the surface of cylinder or cone which having a specified left and right taper and the left taper facing the direction of the right taper and the left taper greater than the right taper, and is also a special dumbbell-shaped bidirectional tapered geometry that has small in the middle and large at both ends and with spiral distributing along the spiral continuously and/or discontinuously. Because of manufacture, the head and tail of asymmetric bidirectional tapered threads may be incomplete bidirectional tapered geometry. Different from modern thread technology, the number of intact and/or incomplete unit body threads, bidirectional tapered thread is no longer in units of teeth, but in units of section, which means, it is not called teeth thread but section thread. The change on the title of thread quantity is based on the change on the thread technical connotation. The threading technology has changed from the meshing relation of internal and external threads of the modern thread to the locking relation between internal and external threads of the bidirectional tapered thread.

The dumbbell-shaped asymmetric bidirectional tapered thread connection pair includes the bidirectional cone body distributed helically on the outer surface of the columnar base body and the bidirectional taper holes distributed helically on the inner surface of the cylindrical base body. That is, including internal and external threads which coordinate with each other. The internal threads are arranged on the bidirectional taper holes with spiral shape and exists in the form of “non-solid space”, while the external thread is arranged on bidirectional cone body with spiral shape and exists as a “material solid”. The nonphysical space refers to a space environment where can accommodate the material entity mentioned above. The inner thread is the container while the outer thread is to be contained. The working status of thread is that the internal and external threads are sections of bidirectional conical geometry that rotate together. The internal and the external threads are held until one side bears both directions, or the left and right sides bear both directions at the same time or until the sizing interference fit. Whether bi-axial load is carried on both sides meanwhile is related to the actual working conditions in the application field. That is, bidirectional conical hole contains bidirectional conical table body section by section, or the internal thread clasps corresponding to the external thread section by section.

The subject thread connection pair is formed by a spiral shaped external cone and a spiral shaped internal cone to cooperate with each other to form a cone pair then to form a thread pair. The outside conical of the bidirectional tapered thread of outer cone and inside conical of inner cone are both bidirectional cones. When the subject bidirectional tapered thread merges into the thread connection pair, it uses the combination of inside conical and outside conical as bearing. That is, using the taper as bearing. To realize the joint technical performance and the self-locking, and the self-positioning, and the re-use and anti-fatigue ability of the thread pair are mainly determined by the conical surface and taper size of the dumbbell-shaped asymmetric bidirectional conical thread connection the pair, namely the conical surface and taper size of the internal and external threads. It is a kind of non-tooth type thread.

It is different from the one-way force distributed on the bevel and the meshing relationship between the inner and outer teeth in the internal and external threads. This kind of bidirectional taper body of dumbbell-shaped asymmetric bidirectional taper thread connection pair, whether distributed on the left or the right side of the single taper body through the conical axis section is composed of two element lines of the cone, which is on the bidirectional state. The subject prime line is an intersection line between a cone surface and a surface passing through a cone axis. The taper principle of this kind of dumbbell-shaped asymmetric bidirectional conical thread connection pair is the axial force and anti-axial force, both of which are synthesized by bidirectional forces. The axial force is opposite to the corresponding anti-axial force, and the internal thread and the external thread are clasped. That is, the forming thread pair is to realize self-positioning or self-locking by means of the internal thread holding the external thread. That is, one taper hole (internal cone) holding the corresponding cone body (external cone) until holding the fixed diameter to achieve self-positioning or until the fixed diameter interference contact. In other words, the internal cone and the external cone are self-locking or self-locating by means of the conical hole and the cone base body are radial locked together to realize the self-locking or self-locating of the thread pair, while the nontraditional thread of internal thread and external thread is composed of thread connection pair by the mutual contact between the tooth bodies to realize the thread connection performance.

There is a self-locking force when the internal thread and the external thread meet certain conditions. The subject self-locking force is generated by the pressure between the inner cone axial force and the outer cone anti-axial force. That is, when the inner cone and the outer cone merge into cone pairs, the inner cone surface of an inner cone is clasped to the outer cone surface of an outer cone body, and the inner cone surface is closely contact with the outer cone surface. The subject inner cone axial force and the outer cone anti-axial force are the unique force concepts to the cone pair technology of subject invention about bidirectional tapered thread technology.

The inner cone is in the form of a bushing. Because of external loads, the inner cone generates axial forces that point or press against the cone axis. The subject axial force is a bidirectional synthesis of the pair of centripetal forces with a conical axis as the center and a mirror distribution and perpendicular to two prime lines of the cone respectively. In other words, the axial force passing through the conical axis section is distributed on both sides of the conical axis in a mirror image and is perpendicular to and pointing to the two prime lines of the cone respectively. That is, the two centripetal force component of the pressure to the common point, and when the cone and spiral structure synthesis for thread and are applied to the deputy axis, is the axis force through the thread section which is made up of screw axis centered in the mirror and/or approximate mirror bidirectional distribution in thread on both sides of the axis and are vertical and pointing to the cone plain wire respectively. That is to say, two centripetal forces which are common and/or approximately common to the thread axes are under compression. The subject axial forces are densely distributed on conical and/or threaded axes in an axial and circumferential manner. The subject axial force corresponds to an axial force angle. The subject angle of the two centripetal forces of the axial forces forms the angle of axial force. The axial force angle depends on the taper size of the cone, that is, the taper angle size.

The outer cone is in the form of an axis, which has a strong ability to absorb various external loads. The outer cone is formed with the opposite axial force of each axial force on inner cone base body. The anti-axial force is a bidirectional synthesis of a pair of anti-centripetal forces with a pair of conical axis as the center and with a mirror distribution and is perpendicular to two prime lines of the cone respectively. In other words, the anti-axial force passing through the conical axis section is distributed on both sides of the conical axis in a mirror image and is perpendicular to the two prime lines of the cone and points from the conical axis in common. That is, pressing on the surface of the cone in two of the centripetal force, and when the cone and spiral structure synthesis for thread and are applied to the thread pair, then the axis force through the axis of the threaded section is made up of screw axis centered in the mirror and/or approximate mirror two-way distribution in thread on both sides of the axis and two perpendicular to the cone plain wire respectively and the thread axis in common and/or approximate in common point, that is, two opposite centripetal forces on the conical surface of the internal thread. The subject anti-axial forces are densely distributed on conical and/or threaded axes in an axial and circumferential manner. The subject anti-axial force corresponds to an anti-axial force angle. The subject angle of the two anti-centripetal forces of the anti-axial forces forms the angle of anti-axial force. The subject anti-axial force angle depends on the taper size of the cone, that is, the taper angle size.

The axial and anti-axial forces begin to form when the inner and outer cones of the conical pair are in effective contact. In other words, there is always a pair of opposite and interacted axial force and anti-axial force in the effective contact progress between the inner cone and the outer cone of the taper pair. The subject axial force and anti-axial force are bidirectional forces with conical axis and/or thread axis as the center and have a mirror image bidirectional distribution instead of unidirectional forces. The subject conical axis and the thread axis are coincident axes which are the same axis and/or approximately the same axis. The subject anti-axial forces and axial forces are inversely collinear, and are inversely collinear and/or approximately inversely collinear when the cone and spiral are combined to form threads and to thread pairs. By holding the inner cone and the outer cone until interference, then the axial force and anti-axial force generate pressure on the contacted surface of the inner cone and the outer cone, and distribute the pressure in the contact surface of the inner cone and the outer cone in the axial direction and circumferentially uniformly. When the inner cone and the outer cone hold together until the pair reaches the interference fit pressure, the inner cone and the outer cone are combined together. That is to say, the above pressure has been able to make the inner cone clasp with outer cone to form a similar integral structure. And after the contributed external force disappears, the external cone and the outer cone will not break away from each other under the action of gravity due to the arbitrary change of the direction of body position of the above similar integral structure. The taper pair produces self-locking, which equal to thread pair producing self-locking. This self-locking also provides limited resistance to external loads other than gravity that may cause the cones to disengage from each other. The conical pair also has the self-positioning property of internal cone and external cone, but not any axial force angle and/or anti-axial force angle can make the conical pair produce self-locking and self-positioning.

When the axial force angle and/or anti-axial force angle is less than 180° and greater than 127°, the conical pair has capability of self-locking. When the axial and/or anti-axial angles are infinitely close to 180°, the conical pair has the best self-locking property and the weakest axial bearing capacity. When the axial force angle and/or the anti-axial force angle are equal to and/or less than 127° and greater than 0°, then the conical pair is in the region of weak and/or no self-locking. When the axial force angle and/or anti-axial force angle tends to change in the direction of infinity close to 0°, then the self-locking property of the conical pairs changes in the direction of attenuation trend until there is no self-locking capability at all, and the axial bearing capacity changes in the direction of enhancement trend until the axial bearing capacity is the strongest.

When the axial force angle and/or anti-axial force angle is less than 180° and greater than 127°, then cone pair is in a strong state of self-positioning, and it is easy to achieve the internal and external cone strong self-positioning. When the axial force angle and/or anti-axial force angle are infinitely close to 180°, then the internal and external cones of the conical pair have the strongest self-positioning ability. When the angle of axial force and/or the angle of anti-axial force is equal to and/or less than 127° and greater than 0°, then the conical pair is in the weak self-positioning state. When the axial force angle and/or anti-axial force angle tends to change towards the direction of infinity close to 0°, then the mutual self-positioning ability of the internal and external cones of the conical pair changes in the direction of attenuation trend until they are close to having no self-positioning ability at all.

The subject bidirectional tapered thread connection pair, compared with the unidirectional tapered thread invented by the inventor before, which can only bear the irreversibility of one side of the conical surface and contain the relationship between being contained and being contained. The bidirectional tapered thread of bidirectional thread body includes the invertibility of both the left and right. It can achieve the bear loading on the left side of the cone and/or the right side of the cone and/or the right side of the cone respectively and/or the left side of the cone and the right side of the cone simultaneously. Moreover, it restricts the disordered freedom between the conical hole and the conical platform body. And the spiral motion enables the asymmetric bidirectional tapered thread connection pair to obtain the necessary ordered degrees of freedom. The technical characteristics of cone pair and thread pairs are synthesized effectively to produce the new thread technology.

When this class of dumbbell-shaped asymmetric bidirectional tapered thread connection pair is in use, the conical surface of bidirectional truncated cone body of the bidirectional taper external thread and the bidirectional conical surface of bidirectional taper hole of the bidirectional taper internal thread coordinate with each other.

The bidirectional taper body constitutes the conical pair of the dumbbell-shaped asymmetric bidirectional tapered thread connection pairs of this class, that is, cone body and/or taper hole are not of arbitrary taper. In other words, any cone angle can realize the self-locking or self-positioning of the thread connection pair. The inner and outer cones of the bidirectional cone must reach a certain taper or a certain cone angle only in this way can asymmetric bidirectional thread connection pairs have the ability of self-locking and self-positioning. The taper comprises the left taper and the right taper of the internal and external screw body. The cone angle comprises the left cone angle and the right cone angle of the internal and external thread body. The internal and external threads of the asymmetric bidirectional conical threads constituting the dumbbell-shaped asymmetric bidirectional tapered thread connection pair of this class are that the left taper is greater than the right taper. The left taper corresponds to the left cone angle, namely the first taper angle α1. Preferably, the first taper angle should be greater than 0° and less than 53°. And more preferably, the first taper angle should be valued between 2° and 40°. And for individual special fields, preferably, the first taper angle is greater than or equal to 53° and less than 180°. And more preferably, the first taper angle should be valued between 53° and 90°. The right taper corresponds to the right cone angle, namely the second taper angle α2. Preferably, the first taper angle should be greater than 0° and less than 53°. And more preferably, the first taper angle should be valued between 2° and 40°.

The specific areas mentioned above refer to threaded connections where self-locking requirements are low or even do not require self-locking and/or self-positioning requirements are weak and/or axial bearing capacity requirements are high and/or anti-lock measures must be in place.

This class of dumbbell-shaped asymmetric bidirectional tapered thread connection pairs, whose external thread is arranged on the external surface of the columnar base body, is characterized in that the external surface of the columnar base body is provided with cone body with the spiral distribution, including the asymmetric bidirectional truncated cone body. The subject cylindrical base body may be solid or hollow and includes workpieces and objects such as cylinder and/or non-cylinder which the threads are required to be machined on its outer surface. The outer surface comprises cylindrical surface and cone surface and/or non-cylindrical surface and other outer surface geometries.

This class of dumbbell-shaped asymmetric bidirectional tapered thread connection pairs, the asymmetric bidirectional truncated cone body, namely the external thread, is characterized in that it is made of the symmetrical and mutual engaged and spiral top face of two taper bodies, which has the same bottom surface and same top surface but different cone height and the left taper of the left cone body is larger than the right taper of the right cone body. And also, the bottom surface is at the end of the bidirectional truncated cone body and when to form the asymmetric bidirectional taper thread, those engaging with the bottom surface of the adjacent bidirectional taper body respectively and/or or those to be engaged with the bottom surface of the adjacent bidirectional taper body respectively to present spiral then to become thread are included. The subject external thread is made of the first spiral conical surface and the second spiral conical surface of cone body and the external spiral. To form asymmetric bidirectional tapered external threads within the section passing through the thread axis. The complete single asymmetric bidirectional taper external thread is a dumbbell-shaped special bidirectional conical geometry with small in the middle and large at both ends and a greater taper of the left cone than that of the right cone. The bidirectional truncated cone body comprises the conical surface of bidirectional truncated cone body. The angle between two prime lines on the left conical surface, namely the first spiral conical surface of cone body is called the first taper angle α1. The first spiral conical surface of cone body forms into left taper distributed to the right. The angle between two prime lines on the right conical surface, namely the second spiral conical surface of cone body is called the second taper angle α2. The second spiral conical surface of cone body forms into right taper distributed to the left. The subject first taper angle α1 is in the direction of the taper to the second taper angle α2. The prime line is intersected between the cone surface and the surface passing through the cone axis. The shape of the first spiral conical surface of cone body and the second spiral conical surface of cone body is same with the spiral outer side of cyclotron formed by the two hypotenuses of the right-angled trapezoid combination. The right-angle side of the right-angled trapezoid combination which is a symmetric combination between top and bottom edges of two right-angled trapezoids. And the right-angled trapezoid has same bottom side and upper side but different right-angle side and coincides with the central axis of the columnar base body. Besides, the right-angled trapezoid combinations move axially at a uniform velocity along the central axis of columnar base body simultaneously. The rectangular trapezoid combination refers to a special geometry body with the upper and lower sides of two rectangular trapezoids having the same lower side and same upper side but different right angled sides, the upper sides of which are symmetric and mutually engaged, and the lower sides are respectively at the both ends of the rectangular trapezoid combination.

This class of dumbbell-shaped asymmetric bidirectional tapered thread connection pairs, the internal thread is arranged on the inner surface of the cylindrical base body, is characterized in that the inner surface of the cylindrical base body is provided with a spiral shaped tapered hole. And the taper hole comprises an asymmetric bidirectional taper hole. The cylindrical base body comprises the cylinder body and/or a non-cylinder body and other workpieces and objects whose internal threads are required to be machined on its inner surface. The inner surface comprises cylindrical surface and cone surface and/or non-cylindrical surface and other inner surface geometries.

This class of dumbbell shaped asymmetric bidirectional tapered thread connection pairs. The subject asymmetric bidirectional taper hole, namely the internal thread, is characterized in that, it is made of the symmetrical and mutual engaged and spiral shape top face of two taper holes, which has the same bottom surface and same top surface but different cone height and the left taper of the left taper hole is larger than the right taper of the right taper hole. And also, the bottom surface is at the end of the bidirectional taper hole and when to form the asymmetric bidirectional taper thread, those engaging with the bottom surface of the adjacent bidirectional taper hole respectively and/or or those to be engaged with the bottom surface of the adjacent bidirectional taper hole respectively to present spiral then to become thread are included. The subject internal thread is made up of the first spiral conical surface and the second spiral conical surface of taper hole and the internal spiral. To form asymmetric bidirectional tapered internal threads within the section passing through the thread axis. The complete single asymmetric bidirectional taper internal thread is a dumbbell-shaped special bidirectional conical geometry with small in the middle and large at both ends and a greater taper of the left taper hole than that of the right cone. The bidirectional taper hole comprises the conical surface of bidirectional taper hole. The angle between two prime lines on the left conical surface, namely the first spiral conical surface of taper hole is called the first taper angle α1. The first spiral conical surface of taper hole forms into left taper distributed to the right. The angle between two prime lines on the right conical surface, namely the second spiral conical surface of taper hole is called the second taper angle α1. The second spiral conical surface of taper forms into right taper distributed to the left. The subject first taper angle α1 is in the direction of the taper to the second taper angle α2. The prime line is intersected between the cone surface and the surface passing through the cone axis. The shape of the first spiral conical surface of taper hole and the second spiral conical surface of taper hole is same with the spiral outer side of cyclotron formed by the two hypotenuses of the right-angled trapezoid combination. The right-angle side of the right-angled trapezoid combination which is a symmetric combination between top and bottom edges of two right-angled trapezoids. And the right-angled trapezoid has same bottom side and upper side but different right-angle side and coincides with the central axis of the cylindrical base body. Besides, the right-angled trapezoid combinations move axially at a uniform velocity along the central axis of cylindrical base body simultaneously. The rectangular trapezoid combination refers to a special geometry body with the upper and lower sides of two rectangular trapezoids having the same lower side and same upper side but different right angled sides, the upper sides of which are symmetric and mutually engaged, and the lower sides are respectively at the both ends of the rectangular trapezoid combination.

In dumbbell-shaped asymmetric bidirectional tapered thread connection pair, the joint of two adjacent spiral conical surfaces of the external thread and two adjacent spiral conical surfaces of the internal thread are associated with sharp angles and/or non-sharp angle setc respectively. The sharp angle is relatively to the non-sharp angle, which refers to the structural form without special non-sharp angle treatment.

In subject dumbbell-shaped asymmetric bidirectional tapered thread connection pair, where the connecting form is a sharp angle, is characterized in that the joint between the first spiral conical surface of the cone body and the second spiral conical surface of the cone body of the bidirectional truncated cone body, that is, the minor diameter of the external thread adopts the structure of inner sharp angle and forms the external spiral with spiral distribution. The joint between the first spiral conical surface of the cone body of the bidirectional truncated cone body and the second spiral conical surface of the cone body of the adjacent bidirectional truncated cone body, and/or the joint between the second spiral conical surface of the cone body of the bidirectional truncated cone body and the first spiral conical surface of the cone body of the adjacent bidirectional truncated cone body, that is, the major diameter of the external thread is connected with the external sharp angle structure and forms an external spiral with spiral distribution. Between the same spiral junction of the first spiral conical surface of the taper hole and the second spiral conical surface of the taper hole of the bidirectional taper hole, that is, the minor diameter of the internal thread adopts the structure of outer sharp angle and forms the internal spiral with spiral distribution. The joint between the first spiral conical surface of the taper hole of the bidirectional taper hole and the second spiral conical surface of the taper hole of the adjacent bidirectional taper hole, and/or the joint between the second spiral conical surface of the taper hole of the bidirectional taper hole and the first spiral conical surface of the taper hole of the adjacent bidirectional taper hole, that is, the major diameter of the internal thread is connected with the internal sharp angle structure and forms an internal spiral with spiral distribution. In this way, the thread would has more compact structure and higher strength and larger bearing capacity, as well as with good mechanical connection, locking, sealing performance, and more spacious taper thread machining physical space.

In subject dumbbell-shaped asymmetric bidirectional tapered thread connection pair, where the connecting form is a non-sharp angle, is characterized in that the joint between the first spiral conical surface of cone boy and the second spiral conical surface of cone boy of the same spiraling bidirectional cone body, that is, the minor diameter of the external thread adopts the structure of inner non-sharp angle and forms the external spiral with spiral distribution or groove or arc. The joint between the first spiral conical surface of the cone body of the bidirectional truncated cone body and the second spiral conical surface of the cone body of the adjacent bidirectional truncated cone body, and/or the joint between the second spiral conical surface of the cone body of the bidirectional truncated cone body and the first spiral conical surface of the cone body of the adjacent bidirectional truncated cone body, that is, the major diameter of the external thread is connected with the external non-sharp angle structure and forms an external spiral with spiral distribution or flat or arc. The joint between the first spiral conical surface of the taper hole and the second spiral conical surface of the taper hole of the bidirectional taper hole, that is, the minor diameter of the internal thread adopts the structure of outer non-sharp angle and forms the internal spiral with spiral distribution or flat or arc. The joint between the first spiral conical surface of the taper hole of the bidirectional taper hole and the second spiral conical surface of the taper hole of the adjacent bidirectional taper hole, and/or the joint between the second spiral conical surface of the taper hole of the bidirectional taper hole and the first spiral conical surface of the taper hole of the adjacent bidirectional taper hole, that is, the major diameter of the internal thread is connected with the internal non-sharp angle structure and forms an internal spiral with spiral distribution or groove or arc. The non-external sharp angle refers to the geometric shape such as plane or arc in its section, which can avoid interference between internal thread and external thread when rotating together, and can store oil and reservoir pollution. During the practical application circumstances, as appropriate, it can be that the minor diameter of external thread, major diameter of internal thread adopts the structure process of groove or arc, while major diameter of external thread. minor diameter of internal thread adopt the structure process of shape angle. And/or it can be that the major diameter of external thread, minor diameter of internal thread adopt the structure process of flat or arc, while minor diameter of external thread, major diameter of internal thread adopt the structure process of shape angle. And/or it can be that minor diameter of external thread, major diameter of internal thread adopt the structure process of groove or arc, while major diameter of external thread, minor diameter of internal thread adopt the structure process of flat or arc etc.

The dumbbell-shaped asymmetric bidirectional tapered thread connection pair is on transmitted through the rotary connection and bidirectional bearing of bidirectional conical internal thread and bidirectional conical external thread, namely the connection of bidirectional taper hole and bidirectional truncated cone body. There must be a clearance between bidirectional conical external thread and bidirectional conical internal thread and if there is oil and other media lubrication between them, it will form a bearing oil film easily. The clearance is conducive to the formation of bearing oil film. The dumbbell-shaped asymmetric bidirectional tapered thread connection pairs are used for drive connections equivalent to a set of sliding bearing pairs consisting of one pair and/or several pairs of sliding bearings. That is, each section of bidirectional tapered internal thread bidirectional corresponds to one bidirectional cone external thread inclusively to form a pair of sliding bearings, the number of which is adjusted according to the application condition. That is, the bidirectional conical internal thread and the bidirectional conical external thread bidirectional joint with each other effectively, that is, bidirectional contact and clasp with each other effectively to contain or be contained thread section. To design in accordance with the working conditions, the bidirectional taper hole contains bidirectional truncated cone body bi-directionally and positioning multi-directionally on radial, axial, angular and circumferential etc. Preferably, the bidirectional truncated cone body is covered by a bidirectional conical hole and assisted by the radial and circumferential main positioning in the axial and angular direction, thus forming a multi-directional positioning of the inner and outer cones until the conical surface of the bidirectional conical hole and the bidirectional conical surface of the bidirectional truncated cone body are locked to realize self-positioning or self-locking until the fixed diameter interference contact is achieved. It is composed of a special taper pair and a thread pair to ensure the transmission connection precision, and efficiency and reliability of tapered thread technology especially asymmetrical bidirectional tapered thread connection pairs.

When the dumbbell-shaped asymmetric bidirectional tapered thread connection pair is on fastening connection and sealing connection, the technical properties of connection, locking, anti-loosing, bearing and sealing are realized through the rotary connection of bidirectional taper hole and bidirectional truncated cone body. That is, the first spiral conical surface of cone body and the first spiral conical surface of the taper hole are fixed straight up to interference, and/or the second spiral conical surface of the cone body and the second spiral conical surface of taper hole are fixed straight up to interference. According to the application conditions, to achieve the one direction load and/or both directions can be carried at the same time. That is, under the guidance of the spiral, the bidirectional truncated cone body and the bidirectional taper hole are centering on the inner cone and the outer cone, until the first spiral conical surface of the taper hole and the first spiral conical surface of the cone body are locked to carry in one direction or both directions at the same time, to carry the diameter matching or until the diameter is in interference contact. And/or the second spiral conical surface of the taper hole and the second spiral conical surface of the cone body are locked to carry in one direction or both directions at the same time, to carry the diameter matching or until the diameter is in interference contact. It is positioned in multiple directions such as radial, axial, angular and circumferential direction, by means of bidirectional inner cone containing bidirectional outer cone. Preferably, the bidirectional truncated cone body is covered by a bidirectional conical hole and assisted by the radial and circumferential main positioning in the axial and angular direction, thus forming a multi-directional positioning of the inner and outer cones until the conical surface of the bidirectional conical hole and the bidirectional conical surface of the bidirectional truncated cone body are locked to realize self-positioning or self-locking until the fixed diameter interference contact is achieved. It is composed of a special conical pair and a thread pair to achieve the technical performance of mechanical mechanism such as connection, locking, anti-loose, bearing and sealing.

Therefore, technical properties of the dumbbell-shaped asymmetric bidirectional conical thread connection pair such as driving accuracy and efficiency, bearing capacity, self-locking force, anti-loose capacity, sealing performance is related to following: the first spiral conical surface of cone body and its formed left taper-the first taper angle α1; the second spiral conical surface of cone body and its formed right taper-the second taper angle α2; the first spiral conical surface of taper hole and its formed left taper-the first taper angle α1; the second spiral conical surface of taper hole and its formed right taper-the second taper angle α2. The material friction coefficient, machining quality and application condition of columnar base body and cylindrical base body also have an effect on it.

In the dumbbell-shaped asymmetric bidirectional tapered thread connection pair, the subject right-angled trapezoid combination turns around at a uniform velocity, the distance of the axial movement of subject right-angled trapezoid combination is at least double length of the sum of the right-angle sides of the two right-angled trapezoids, which have the same bottom side and upper side but different right-angle sides. The structure ensures that the first spiral conical surface and the second spiral conical surface of the cone body, and the first spiral conical surface and the second spiral conical surface of the taper hole have sufficient length. In this way, the conical surface of the bidirectional truncated cone body and the conical surface of the bidirectional taper hole can have enough effective contact area and strength as well as the efficiency required by the spiral motion.

In the dumbbell-shaped asymmetric bidirectional tapered thread connection pair, the subject right-angled trapezoid combination turns around at a uniform velocity, the distance of the axial movement of subject right-angled trapezoid combination is equal to the sum of the right-angle sides of the two right-angled trapezoids, which have the same bottom side and upper side but different right-angle sides. The structure ensures that the first spiral conical surface and the second spiral conical surface of the cone body, and the first spiral conical surface and the second spiral conical surface of the taper hole have sufficient length. In this way, the conical surface of the bidirectional truncated cone body and the conical surface of the bidirectional taper hole can have enough effective contact area and strength as well as the efficiency required by the spiral motion.

In subject dumbbell-shaped asymmetric bidirectional tapered thread connection pair, the first spiral conical surface and the second spiral conical surface of the cone body are both continuous helical or discontinuous helical surfaces; The first spiral conical surface and the second spiral conical surface of the taper hole are both continuous helical or discontinuous helical surfaces. Preferably, the first spiral conical surface and the second spiral conical surface of the cone body, and the first spiral conical surface and the second spiral conical surface of the taper hole here are all continuous helical surfaces.

In the subject dumbbell-shaped asymmetric bidirectional tapered thread connection pair, when the connecting hole of the cylindrical base body is screwed into the connecting end of the columnar base body, there is a requirement for the direction of screw-in, that is, the connecting hole of the cylindrical base body cannot be screwed in the opposite direction. The contact surface of the first spiral conical surface of the cone body and the first spiral conical surface of the taper hole is the supporting surface and/or interference fit. And/or the contact surface of the second spiral conical surface of the cone body and the second spiral conical surface of the taper hole is the supporting surface and/or interference fit.

The taper direction of the first taper angle is opposite to that of the second taper angle. Here the first angle is the angle between two prime lines on the left conical surface (the first spiral conical surface) of the internal thread and/or the external thread, while the second angle is the angle between two prime lines on the right conical surface (the second spiral conical surface) of the internal thread and/or the external thread. The thread connection function is realized by the contact and/or interference fit between the first spiral conical surface of the internal thread and the first spiral conical surface of the external thread, and/or the contact and/or interference fit between the second spiral conical surface of the internal thread and the second spiral conical surface of the external thread.

In subject dumbbell-shaped asymmetric bidirectional tapered thread connection pair, one end of the columnar base body is provided with the size which is larger than the head of outer diameter of the columnar base body. And/or one end and/or two ends of the columnar base body are all provided with the size which is smaller than the head of bidirectional taper external thread minor diameter of columnar base body screw body. The connection hole is a threaded hole arranged on a nut body. That is, the columnar base body connecting to the head is considered as bolt, and those without the head and/or the two ends of the head are smaller than the diameter of the bidirectional taper external thread and/or without thread in the middle but with bidirectional taperexternal thread at the both ends are studs. The connection hole is arranged in the nut body.

Compared with the existing technology, the advantage of this kind of dumbbell-shaped asymmetric double tapered thread connection pair are as following:

Reasonable design;

Simple structure;

To realize the functions of fastening and connecting by the bidirectional bearing or fix-diameter of thread pairs until interference fit. The thread pairs is formed by the centering of Coaxial inner and outer diameters of inner, outer cone.

Easy operation;

Large locking force;

Large bearing force;

Good anti-loose performance;

High transmission efficiency and precision;

Good mechanical sealing efficiency;

Good stability;

Can prevent looseness when connecting;

With self-locking and self-positioning functions.

### BRIEF DESCRIPTION OF THE DRAWINGS

Exemplary embodiments of this invention are explained below with the aid of the schematic drawings, in which:

FIG. 1 shows a first exemplary embodiment of the invention, in which the dumbbell-shaped asymmetric bidirectional tapered thread connection pair having a lager left taper and a small right taper.

FIG. 2 shows a first exemplary embodiment of the invention, in which the external thread and external thread integrated unit of the dumbbell-shaped asymmetric bidirectional tapered thread having a lager left taper and a small right taper.

FIG. 3 shows a first exemplary embodiment of the invention, in which the internal thread and internal thread integrated unit of the dumbbell-shaped asymmetric bidirectional tapered thread having a lager left taper and a small right taper.

FIG. 4 shows a second exemplary embodiment of the invention, in which the dumbbell-shaped asymmetric bidirectional tapered thread connection pair having a lager left taper and a small right taper.

FIG. 5 shows a third exemplary embodiment of the invention, in which the dumbbell-shaped asymmetric bidirectional tapered thread connection pair having a lager left taper and a small right taper.

FIG. 6 shows a fourth exemplary embodiment of the invention, in which the dumbbell-shaped asymmetric bidirectional tapered thread connection pair having a lager left taper and a small right taper.

FIG. 7 shows a fifth exemplary embodiment of the invention, in which the dumbbell-shaped asymmetric bidirectional tapered thread connection pair having a lager left taper and a small right taper.

FIG. 8 shows the background technology involved of the invention, in which the thread of the existing thread technology is the bevel of cylinder or taper surface.

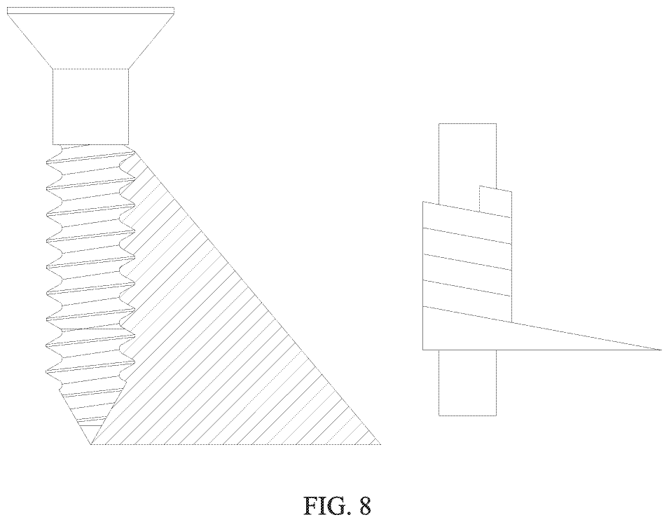

FIG. 9 shows the background technology involved of the invention, in which the model of bevel module of existing thread technology-bevel principle.

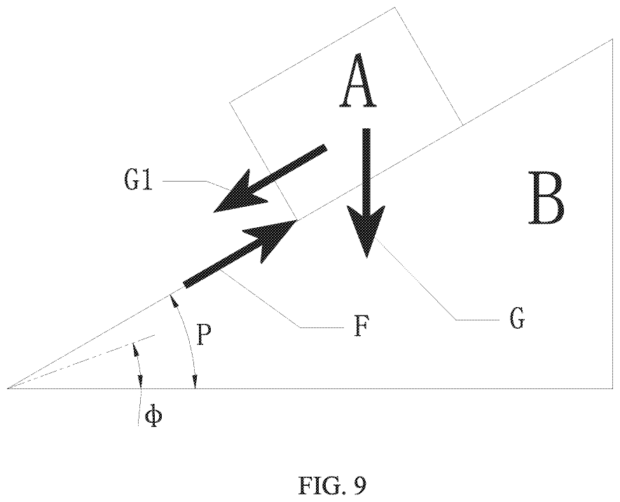

FIG. 10 shows the background technology involved of the invention, in which the spiral angle of existing thread technology.

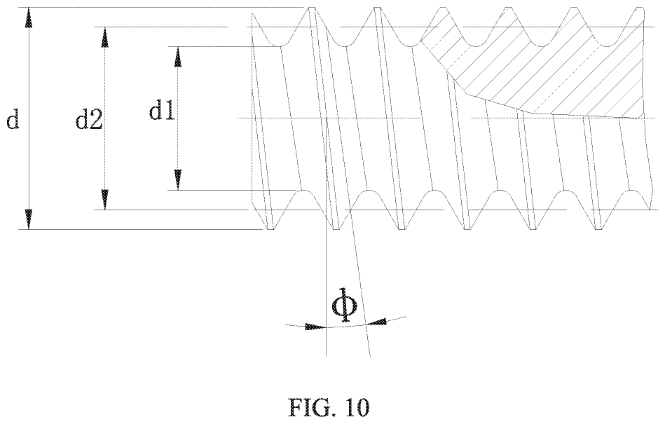

Elements of the same design and function are labeled with the same reference symbol as following throughout the drawings:
tapered thread 1;
cylindrical base body 2;
nut body 21;
columnar base body 3;
screw body 31;
taper hole 4;
bidirectional taper hole 41;
conical surface of bidirectional taper hole 42;
the first spiral conical surface of taper hole 421;
the first taper angle α1;
the second spiral conical surface of taper hole 422;
the second taper angle α2;
internal spiral 5;
internal thread 6;
internal thread groove of bidirectional taper hole 61;
internal thread surface or arc of bidirectional taper hole 62;
cone body 7;
bidirectional truncated cone base body 71;
conical surface of bidirectional truncated cone body 72;
the first spiral conical surface of cone body 721;
the first taper angle α1;
the second spiral conical surface of cone body 722;
the second taper angle α2;
External spiral 8;
External thread 9;
external thread groove of bidirectional taper hole 91;
External thread surface or arc of bidirectional taper hole 92;
dumbbell-shaped 94;
left taper 95;
right taper 96;
left distribution 97;
Right distribution 98;
thread connection pair and/or thread pair 10;
clearance 101;
taper axis 01;
thread axis 02;
slider on inclined surface A;
Clinohedral B;
gravity G;
gravity along bevel G1;
force of friction F;
spiral angle φ;
equivalent angle of friction P;
major diameter of conventional external thread d;
minor diameter of conventional external thread d1;
media diameter of conventional external thread d2.

### DETAILED DESCRIPTION OF EMBODIMENTS

The following is a further detailed illustration of the invention combined schematic drawings with the attached drawings and concrete implementing ways.

### Exemplary Embodiment 1

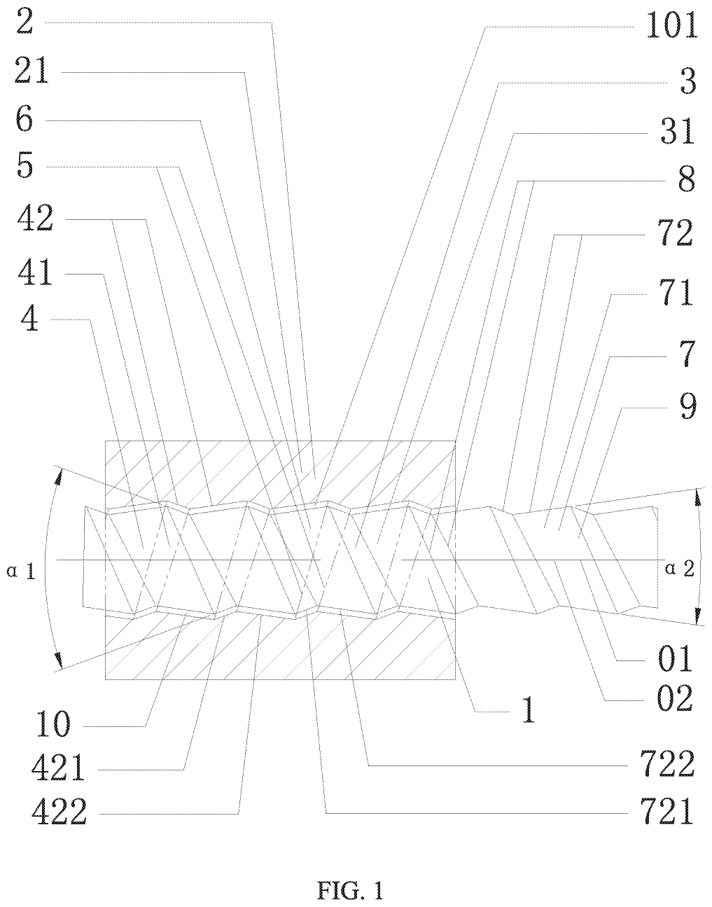

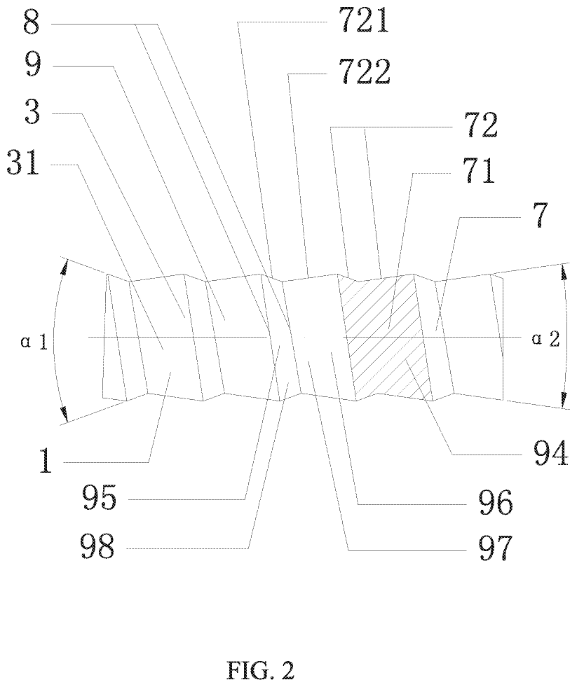

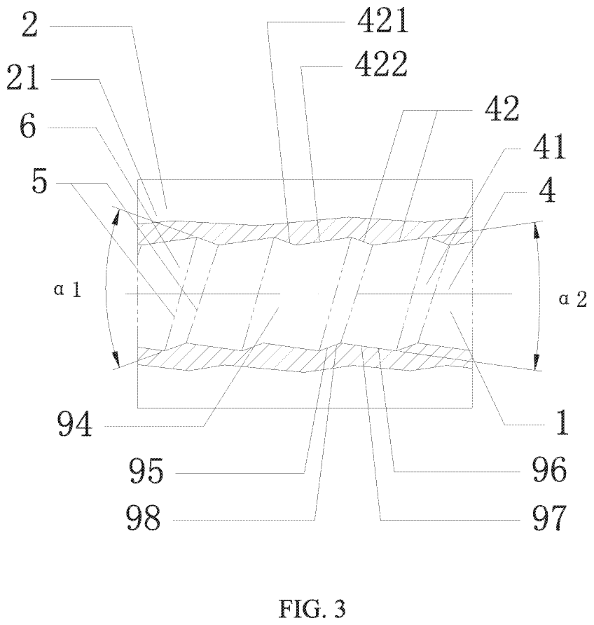

As shown in FIGS. 1, 2 and 3, the dumbbell-shaped asymmetric bidirectional tapered thread connection pair includes spiraling bidirectional truncated cone body 71 distributed on outer surface of columnar base body 3 and spiraling bidirectional taper hole 41 distributed on inner surface of cylindrical base body 2. That is, includes the external thread 9 and internal thread 6 concerting with each other. The distribution of the internal thread 6 is spiraling bidirectional taper hole 41 with “incorporeal space” form, and the distribution of the external thread 9 is spiraling bidirectional cone base body 71 with “material entities” form. The internal thread 6 and the external thread 9 is the relationship between female parts and male parts. The internal thread 6 and external thread 9 are sections of bidirectional conical geometry that rotate and socket together and hold until interference fit. That is, bidirectional taper hole 41 contains bidirectional truncated cone body 71 section by section, and inclusive bi-directionally and limits the disordered freedom between taper hole 4 and cone body 7, while the spiral motion makes asymmetric bidirectional tapered thread connection pair 10 to obtain necessary ordered degrees of freedom, to synthesize the technical characteristics of cone pair and thread pair.

During the use of dumbbell-shaped asymmetric bidirectional tapered thread connection pair in this embodiment, the conical surface of bidirectional cone body 72 and the conical surface of bidirectional taper hole 42 cooperate with each other.

In this embodiment, the cone body 7 and/or taper hole 4 of the dumbbell-shaped asymmetric bidirectional tapered thread connection pair reach a certain taper. That is, not until the taper body that forms to taper pair reaches a certain taper angle, the asymmetric bidirectional tapered thread connection pair 10 has ability of self-locking and self-positioning. The taper comprises the left taper 95 and the right taper 96. The taper angle comprises the left taper angle and the right taper angle. The asymmetric bidirectional taper thread 1 has the greater left taper 95 and smaller right taper 96. The left taper 95 corresponds to the left taper angle, namely the first taper angle α1. Preferably, 0°<α1<53°. And more preferably, the first taper angle α1 should be valued between 2°˜40°. And for individual special fields where self-locking and/or self-positioning requirements are weak and/or high axial bearing capacity requirements are not required, preferably, 53°≤α1<180°, preferably, the first taper angle α1 should be valued between 53°˜90°. The right taper 96 corresponds to the right taper angle, namely the second taper angle α2. Preferably, 0°<α2<53°. And more preferably, the second taper angle α2 should be valued between 2°˜40°.

The external thread 9 is arranged on the external surface of the columnar base body 3, is characterized in that: the columnar base body 3 has screw body 31, and the outer surface of the screw body 31 has a cone body 7 with spiral distribution. The cone body 7 comprises an asymmetric bidirectional truncated cone body 71. The asymmetrical bidirectional truncated cone body 71 is a special bidirectional taper geometry with dumbbell-shaped 94. The columnar base body 3 can be solid or hollow, including the cylinder body, the cone body, the pipe body etc.

The dumbbell-shaped 94 asymmetric bidirectional truncated cone body 71, is characterized in that it is made of the symmetrical and mutual engaged and spiral top face of two cone bodies, which has the same bottom surface and same top surface but different cone height and the left taper of the left cone body is larger than the right taper of the right cone body. And also, the bottom surface is at the end of the bidirectional truncated cone body 71 and when to form the dumbbell-shaped 94 asymmetric bidirectional taper thread 1, those engaging with the bottom surface of the adjacent bidirectional cone body 71 respectively and/or or those to be engaged with the bottom surface of the adjacent bidirectional cone body 71 respectively are included. The outer surface of cone body 7 has conical surface of asymmetric bidirectional cone body 72. The subject external thread 9 is made of the first spiral conical surface 721 and the second spiral conical surface 722 of cone body and the external spiral 8. Within the cross section passing through the thread axis 02, the complete single asymmetric bidirectional taper external thread 9 is a dumbbell-shaped 94 special bidirectional conical geometry with small in the middle and large at both ends and a greater taper of the left cone than that of the right cone. The angle between two prime lines on the left conical surface, namely the first spiral conical surface of cone body 721 of the bidirectional truncated cone body 71 is called the first taper angle α1. The first spiral conical surface of cone body 721 forms into left taper 95 corresponding to the first taper angle α1 and with right distribution 98. The angle between two prime lines on the right conical surface, namely the second spiral conical surface of cone body 722 of the bidirectional truncated cone body 72 is called the second taper angle α2. The second spiral conical surface of cone body 722 forms into right taper 96 corresponding to the second taper angle α2 and with left distribution 97. The subject first taper angle α1 is in the direction of the taper to the second taper angle α2. The prime line is intersected between the cone surface and the surface passing through the taper axis 01. The shape formed by the first spiral conical surface of cone body 721 and the second spiral conical surface of cone body 722 of the bidirectional cone body 71 is same with the spiral outer side of cyclotron formed by the two hypotenuses of the right-angled trapezoid combination. The right-angle side of the right-angled trapezoid combination is a symmetric combination from upper edges of two right-angled trapezoids. And the right-angled trapezoid has same bottom side and upper side but different right-angle side and coincides with the central axis of the columnar base body 3. Besides, the right-angled trapezoid combinations move axially at a uniform velocity along the central axis of columnar base body 3 simultaneously. The rectangular trapezoid combination refers to a special geometry body with the upper and lower sides of two rectangular trapezoids having the same lower side and same upper side but different right angled sides, the upper sides of which are symmetric and mutually engaged, and the lower sides are respectively at the both ends of the rectangular trapezoid combination.

The internal thread 6 is arranged on the inner surface of cylindrical base body 2, which is characterized by that the cylindrical base body 2 has a nut body 21. The inner surface of the nut body 21 has a taper hole 4 with helical distribution. The taper hole 4 comprises an asymmetric bidirectional taper hole 41, which is a special bidirectional taper geometry with dumbbell-shaped 94. The cylindrical base body 2 comprises the cylinder body and/or the non-cylinder body and other workpieces and objects whose internal threads are required to be machined on its inner surface.

The dumbbell-shaped 94 asymmetric bidirectional taper hole 41, is characterized in that it is made of the symmetrical and mutual engaged and spiral shape top face of two taper holes, which has the same bottom surface and same top surface but different cone height and the left taper of the left taper hole is larger than the right taper of the right taper hole. And also, the bottom surface is at the end of the bidirectional taper hole 41 and when to form the dumbbell-shaped 94 asymmetric bidirectional taper thread 1, those engaging with the bottom surface of the adjacent bidirectional taper hole 41 respectively and/or or those to be engaged with the bottom surface of the adjacent bidirectional taper hole 41. The taper hole 41 comprises the conical surface of asymmetric bidirectional taper hole 42. The subject internal thread 6 is made up of the first spiral conical surface 421 and the second spiral conical surface 422 of taper hole and the internal spiral 5. Within the cross section passing through the thread axis 02, the complete single asymmetric bidirectional taper internal thread 6 is a dumbbell-shaped 94 special bidirectional conical geometry with small in the middle and large at both ends and a greater taper of the left taper hole than that of the right cone. The angle between two prime lines on the left conical surface, namely the first spiral conical surface of taper hole 421 of the bidirectional taper hole 41 is called the first taper angle α1. The first spiral conical surface of taper hole 421 forms into left taper 95 corresponding to the first taper angle α1 and with right distribution 98. The angle between two prime lines on the right conical surface, namely the second spiral conical surface of taper hole 422 of the bidirectional taper hole 42 is called the second taper angle α2. The second spiral conical surface of taper hole 422 forms into right taper 96 corresponding to the second taper angle α2 and with left distribution 97. The subject first taper angle α1 is in the direction of the taper to the second taper angle α2. The prime line is intersected between the cone surface and the surface passing through the taper axis 01. The shape formed by the first spiral conical surface of taper body 421 and the second spiral conical surface of taper hole 422 of the bidirectional taper hole 41 is same with the spiral outer side of cyclotron formed by the two hypotenuses of the right-angled trapezoid combination. The right-angle side of the right-angled trapezoid combination is a symmetric combination from upper edges of two right-angled trapezoids. And the right-angled trapezoid has same bottom side and upper side but different right-angle side and coincides with the central axis of the cylindrical base body 2. Besides, the right-angled trapezoid combinations move axially at a uniform velocity along the central axis of cylindrical base body 2 simultaneously. The rectangular trapezoid combination refers to a special geometry body with the upper and lower sides of two rectangular trapezoids having the same lower side and same upper side but different right angled sides, the upper sides of which are symmetric and mutually engaged, and the lower sides are respectively at the both ends of the rectangular trapezoid combination.

In subject embodiment of dumbbell-shaped asymmetric bidirectional tapered thread connection pair, the joint of adjacent spiral conical surface of external thread 9 and internal thread 6 adopt the form of sharp angles linkage. The sharp angle is relatively to the non-sharp angle, which refers to the structural form without special non-sharp angle treatment.

The dumbbell-shaped 94 bidirectional cone body 71 and bidirectional taper hole 41, is characterized in that, the joint between the first spiral conical surface of cone boy 721 and the second spiral conical surface of cone boy 722 of the same spiraling bidirectional cone body 71, that is, the minor diameter of the external thread 9 adopts the structure of inner sharp angle and forms the external spiral 8 with spiral distribution. The joint between the first spiral conical surface of the cone body 721 of the bidirectional truncated cone body 71 and the second spiral conical surface of the cone body 722 of the adjacent bidirectional truncated cone body 71, and/or the joint between the second spiral conical surface of the cone body 722 of the bidirectional truncated cone body 71 and the first spiral conical surface of the cone body 721 of the adjacent bidirectional truncated cone body 71, that is, the major diameter of the external thread 9 is connected with the external sharp angle structure and forms an external spiral 8 with spiral distribution. The joint between the first spiral conical surface of the taper hole 421 and the second spiral conical surface of the taper hole 422 of the bidirectional taper hole 41, that is, the minor diameter of the internal thread 6 adopts the structure of outer sharp angle and forms the internal spiral 5 with spiral distribution. The joint between the first spiral conical surface of the taper hole 421 of the bidirectional taper hole 41 and the second spiral conical surface of the taper hole 422 of the adjacent bidirectional taper hole 41, and/or the joint between the second spiral conical surface of the taper hole 422 of the bidirectional taper hole 41 and the first spiral conical surface of the taper hole 421 of the adjacent bidirectional taper hole 41, that is, the major diameter of the internal thread 6 is connected with the internal sharp angle structure and forms an internal spiral 5 with spiral distribution. In this way, the taper thread 1 would have more compact structure and higher strength and larger bearing capacity, as well as with good mechanical connection, locking, sealing performance, and more spacious machining physical space.

The dumbbell-shaped asymmetric bidirectional tapered thread connection pair is on transmitted through the rotary connection and bidirectional bearing of bidirectional taper hole 41 and bidirectional truncated cone body 71. There must be a clearance 101 between internal thread 6 and external thread 9 when they form to thread pair 10. That is, there should be a clearance 101 between the bidirectional taper hole 41 and bidirectional truncated cone body 71. If there is oil and other media lubrication between them, it will form a bearing oil film easily. The clearance 101 is conducive to the formation of bearing oil film. The dumbbell-shaped asymmetric bidirectional tapered thread connection pairs 10 are used for drive connections equivalent to a set of sliding bearing pairs consisting of one pair and/or several pairs of sliding bearings. That is, each section of bidirectional tapered internal thread 6 bidirectional corresponds to one section of the bidirectional cone external thread 9 inclusively to form a pair of sliding bearings, the number of which is adjusted according to the application condition. That is, the bidirectional conical internal thread 6 and the bidirectional conical external thread 9 bi-directionally contact and clasp with each other effectively to contain or be contained thread section. To design in accordance with the working conditions, the bidirectional conical internal thread 6 contains the bidirectional conical external thread 9 and assisted by multi-positioning such as radial, axial, angular, circumferential etc. Thus, forming the special synthetic technique of the taper pair and thread pair to ensure the accuracy, efficiency and reliability of the taper thread technique, especially the dumbbell-shaped asymmetric bidirectional tapered thread connection pair 10.

When the dumbbell-shaped asymmetric bidirectional tapered thread connection pair is on fastening connection and sealing connection, the technical properties of connection, locking, anti-loosing, bearing and sealing are realized through the rotary connection of bidirectional taper hole 41 and bidirectional truncated cone body 71. That is, the first spiral conical surface of cone body 721 and the first spiral conical surface of the taper hole 421 are fixed straight up to interference, and/or the second spiral conical surface of the cone body 722 and the second spiral conical surface of taper hole 422 are fixed straight up to interference. According to the application conditions, to achieve the one direction load and/or both directions can be carried at the same time, that is, under the guidance of the spiral, the bidirectional truncated cone body 71 and the bidirectional taper hole 41 are centering on the inner cone and the outer cone, until the first spiral conical surface of the taper hole 421 and the first spiral conical surface of the cone body 721 are locked to carry in one direction or both directions at the same time, to carry the diameter matching or until the diameter is in interference contact. And/or the second spiral conical surface of the taper hole 422 and the second spiral conical surface of the cone body 722 are locked to carry in one direction or both directions at the same time, to carry the diameter matching or until the diameter is in interference contact. Thus, to achieve the technical performance of mechanical mechanism such as connection, locking, anti-loose, bearing and sealing etc.

Therefore, technical properties of the dumbbell-shaped asymmetric bidirectional conical thread connection pair such as driving accuracy and efficiency, bearing capacity, self-locking force, anti-loose capacity, sealing performance is related to following: the first spiral conical surface of cone body 721 and its formed left taper 95, namely the first taper angle α1; the second spiral conical surface of cone body 722 and its formed right taper 96, namely the second taper angle α2; the first spiral conical surface of taper hole 421 and its formed left taper 95, namely the first taper angle α1; the second spiral conical surface of taper hole 422 and its formed right taper 96, namely the second taper angle α2. The material friction coefficient, machining quality and application condition of columnar base body 3 and cylindrical base body 2 also have an effect on it.

In the dumbbell-shaped asymmetric bidirectional tapered thread connection pair, the subject right-angled trapezoid combination turns around at a uniform velocity, the distance of the axial movement of subject right-angled trapezoid combination is at least double length of the sum of the right-angle sides of the two right-angled trapezoids, which have the same bottom side and upper side but different right-angle sides. The structure ensures that the first spiral conical surface 721 and the second spiral conical surface 722 of the cone body, and the first spiral conical surface 421 and the second spiral conical surface 422 of the taper hole have sufficient length. In this way, the conical surface of the bidirectional truncated cone body 72 and the conical surface of the bidirectional taper hole 42 can have enough effective contact area and strength as well as the efficiency required by the spiral motion.

In the dumbbell-shaped asymmetric bidirectional tapered thread connection pair, the subject right-angled trapezoid combination turns around at a uniform velocity, the distance of the axial movement of subject right-angled trapezoid combination is equal to the sum of the right-angle sides of the two right-angled trapezoids, which have the same bottom side and upper side but different right-angle sides. The structure ensures that the first spiral conical surface 721 and the second spiral conical surface 722 of the cone body, and the first spiral conical surface 421 and the second spiral conical surface 422 of the taper hole have sufficient length. In this way, the conical surface of the bidirectional truncated cone body 72 and the conical surface of the bidirectional taper hole 42 can have enough effective contact area and strength as well as the efficiency required by the spiral motion.

In subject dumbbell-shaped asymmetric bidirectional tapered thread connection pair, the first spiral conical surface 721 and the second spiral conical surface 722 of the cone body are both continuous helical or discontinuous helical surfaces. The first spiral conical surface 421 and the second spiral conical surface 422 of the taper hole are both continuous helical or discontinuous helical surfaces. Preferably, the first spiral conical surface 721 and the second spiral conical surface 722 of the cone body, and the first spiral conical surface 421 and the second spiral conical surface 422 of the taper hole here are all continuous helical surfaces.

In the dumbbell-shaped asymmetric bidirectional tapered thread connection pair, when the connecting hole of the cylindrical base body 2 is screwed into the connecting end of the columnar base body 3, there is a requirement for the direction of screw-in, that is, the connecting hole of the cylindrical base body 2 cannot be screwed in the opposite direction.

In subject dumbbell-shaped asymmetric bidirectional tapered thread connection pair, one end of the columnar base body 3 is provided with the size which is larger than the head of outer diameter of the columnar base body 3. And/or one end and/or two ends of the columnar base body 3 are all provided with the size which is smaller than the head of bidirectional taper external thread 9 minor diameter of columnar base body 3 screw body 31. The connection hole is a threaded hole arranged on a nut body 21. That is, the columnar base body 31 connecting to the head is considered as bolt, and those without the head and/or the two ends of the head are smaller than the diameter of the bidirectional taper external thread 9 and/or without thread in the middle but with bidirectional taper external thread 9 at the both ends are studs. The connection hole is arranged in the nut body 21.

Compared with the existing technology, the advantages of this kind of dumbbell-shaped asymmetric double tapered thread connection pair are as following:

Reasonable design;

Simple structure;

To realize the functions of fastening and connecting by the bidirectional bearing or fix-diameter of thread pairs until interference fit. The thread pairs is formed by the centering of coaxial inner and outer diameters of inner and outer cone.

Easy operation;

Large locking force;

Large bearing force;

Good anti-loose performance;

High transmission efficiency and precision;

Good mechanical sealing efficiency;

Good stability;

Can prevent looseness when connecting;

With self-locking and self-positioning functions.

### Exemplary Embodiment 2

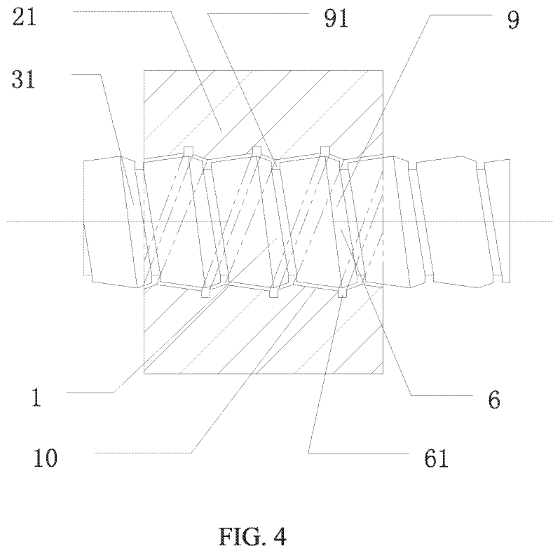

As shown in FIG. 4, the structure, principle and implementation steps of this embodiment are similar to those of Embodiment 1. The difference is the minor diameter of the external thread 9 is treated with the external helix structure connected with the groove 91, and the outer helix structure is a special external spiral 8. The major diameter of the internal thread 6, namely the joint of the adjacent spiral conical surface, is treated with the internal helix structure connected with the groove 61. The inner helix structure is a special internal spiral 5, which can avoid interference between the internal thread 6 and the external thread 9 when rotating together, and also store oil and reservoir pollution.

### Exemplary Embodiment 3

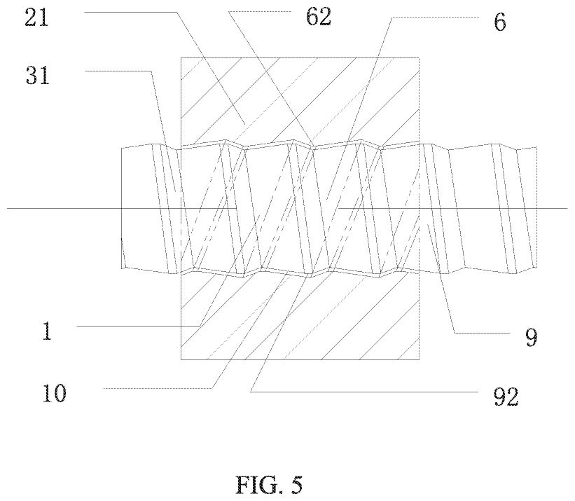

As shown in FIG. 5, the structure, principle and implementation steps of this embodiment are similar to those of Embodiment 1. The difference is the major diameter of the external thread 9, namely the joint of the adjacent spiral conical surface is treated with the external helix structure connected with the plane or arc 92, and the outer helix structure is a special external spiral 8. The minor diameter of the internal thread 6 is treated with the internal helix structure connected with the plane or arc 62. The inner helix structure is a special internal spiral 5, which can avoid interference between the internal thread 6 and the external thread 9 when rotating together, and also store oil and reservoir pollution.

### Exemplary Embodiment 4

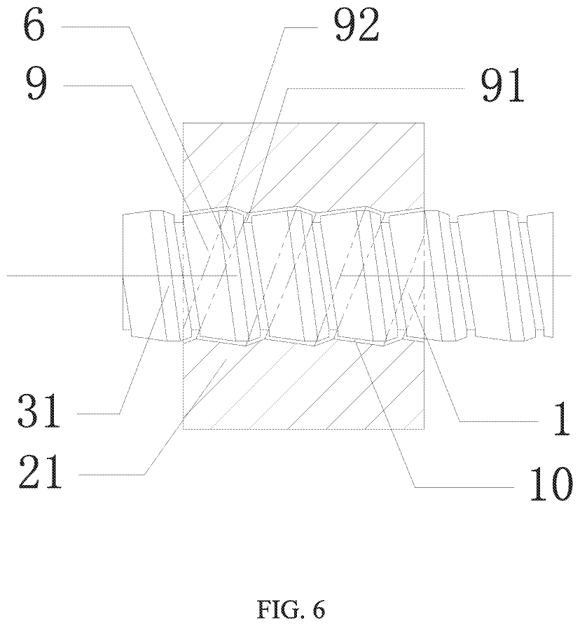

As shown in FIG. 6, the structure, principle and implementation steps of this embodiment are similar to those of Embodiment 1. The difference is the minor diameter of the external thread 9 is treated with the external helix structure connected with the groove 91. The major diameter of the external thread 9, namely the joint of the adjacent spiral conical surface is treated with the external helix structure connected with the plane or arc 92. The outer helix structure is a special external spiral 8. The thread pair 10 is constituted by the special external spiral 8 and the internal thread 6. Both the minor and major diameter of internal thread 6 use sharp angle for connection to avoid the possible R angle, which can avoid interference between the internal thread 6 and the external thread 9 when rotating together, and also can store oil and reservoir pollution.

### Exemplary Embodiment 5

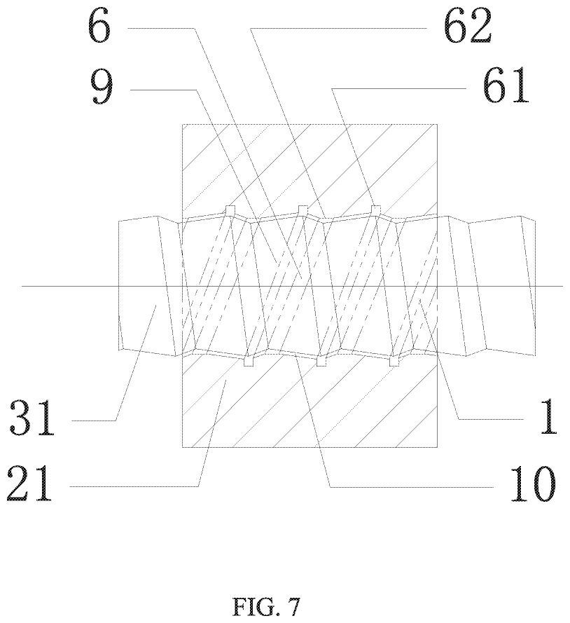

As shown in FIG. 7, the structure, principle and implementation steps of this embodiment are similar to those of Embodiment 1. The difference is the major diameter of the internal thread 6, namely the joint of the adjacent spiral conical surface is treated with the internal helix structure connected with groove 61. The minor diameter of the internal thread 6 is treated with the internal helix structure connected with the plane or arc 62. The inner helix structure is a special internal spiral 5. The thread pair 10 is constituted by the special internal spiral 5 and the external thread 9. Both the minor and major diameter of external thread 9 use sharp angle for connection to avoid the possible R angle, which can avoid interference between the internal thread 6 and the external thread 9 when rotating together, and also store oil and reservoir pollution.

The specific embodiments described herein are merely illustrative of the spirit of the invention. The technical personnel in the technical field of the invention may make various modifications or additions to the specific embodiments described or replace them in a similar manner, but without deviating from the spirit of the invention or going beyond the scope defined in the attached claims.

Although below terms are used a lot in this article: tapered thread 1, cylindrical base body 2, nut body 21, columnar base body 3, screw body 31, taper hole 4, bidirectional taper hole 41, conical surface of bidirectional taper hole 42, the first spiral conical surface of taper hole 421, the first taper angle α1, the second spiral conical surface of taper hole 422, the second taper angle α2, internal spiral 5, internal thread 6, internal thread groove of bidirectional taper hole 61, internal thread surface or arc of bidirectional taper hole 62, cone body 7, bidirectional truncated cone base body 71, conical surface of bidirectional truncated cone body 72, the first spiral conical surface of cone body 721, the first taper angle α1, the second spiral conical surface of cone body 722, the second taper angle α2, external spiral 8, external thread 9; external thread groove of bidirectional taper hole 91, external thread surface or arc of bidirectional taper hole 92, dumbbell-shaped 94, left taper 95, right taper 96, left distribution 97, right distribution 98, thread connection pair and/or thread pair 10, clearance 101, self-locking force self-locking self-positioning, pressure, taper axis 01, thread axis 02, mirror, axle sleeve, axis, the entity space, material entity, single taper, bidirectional taper, cone, internal cone, taper hole, external cone, taper, taper pair, spiral structure, spiral motion, thread body, complete unit thread, axis force, axis force angle, anti-axis force, anti-axis force angle, centripetal force, anti-centripetal force, reverse collinear force, internal stress, bidirectional force, one-way force, sliding bearing, sliding bearing pair etc. However, the possibility of using other terms does not preclude the use of such terms. Using those terms are merely for the purpose of more convenient description and explanation of the nature of the present invention. It would be contrary to the spirit of the present invention to interpret them as any additional limitation.

What is claimed is:

1. A dumbbell-shaped asymmetric bidirectional tapered threaded connection pair having lager left taper and a small right taper, or a dumbbell like (a left taper is greater than a right taper) asymmetric bidirectional tapered thread connection pair comprising an external thread (9) and an internal thread (6) threaded to the external thread (9); wherein a thread of the complete body of the dumbbell-shaped (left taper is greater than the right one) asymmetric bidirectional tapered thread (1) is a spiral shaped cone with small middle ends and large ends and a left taper (95) is larger than the right taper (96), including bidirectional taper hole (41) and/or bidirectional truncated cone body (71); a threaded body of the internal thread (6) is a cylindrical base body (2) with a spiral bidirectional taper hole (41) on the inner surface and presented in the form of non-solid space; the threaded body of the external thread (9) is a cylindrical matrix (3) with a spiral bidirectional truncated cone body (71) on outer surface and presented in the form of a material solid; the left taper of the asymmetric bidirectional cone forms the left taper (95) corresponding to a first taper angle (α1), and the right cone forms the right taper (96) corresponding to the second taper angle (α2); the left taper (95) and right taper (96) have opposite direction and different taper; the internal thread (6) and the external thread (9) pass through the cone hole to enclose the cone until the surface of the inner cone and outer cone bear on each other; a technical performance depends mainly on the taper and the taper of the threaded body; preferably, both the first taper angle (α1) and the second taper angle (α2) should be greater than 0° and less than 53°; and for individual special fields, preferably, the first taper angle (α1) is greater than or equal to 53° and less than 180°.

2. The threaded connection pair of claim 1, wherein the subject dumbbell-shaped (94) bidirectional conical internal thread (6) includes the left conical surface of bidirectional taper hole (42), namely the first spiral conical surface of taper hole (421) and the right conical surface, namely the second spiral conical plane of taper hole (422) and the internal spiral (5); the first spiral conical surface of taper hole (421) and the second spiral conical plane of taper hole (422), namely the shape of bidirectional spiral cone is same with the spiral outer side of cyclotron formed by the two hypotenuses of the right-angled trapezoid combination; the right-angle side of the right-angled trapezoid combination which is a symmetric combination between top and bottom edges of two right-angled trapezoids; and the right-angled trapezoid has same bottom side and upper side but different right-angle side and coincides with the central axis of the cylindrical nut (2); the right-angled trapezoid combinations move axially at a uniform velocity along the central axis of cylindrical nut (2) simultaneously; the dumbbell-shaped (94) bidirectional conical external thread (9) includes the left conical surface of bidirectional truncated cone body (72), namely the first spiral conical surface of cone body (721) and the right conical surface, namely the second spiral conical surface of cone body (722) and the external spiral (8); the first spiral conical surface of cone body (721) and the second spiral conical surface of cone body (722), namely the shape of bidirectional spiral cone is same with the spiral outer side of cyclotron formed by the two hypotenuses of the right-angled trapezoid combination; the right-angle side of the right-angled trapezoid combination which is a symmetric combination between top and bottom edges of two right-angled trapezoids; and the right-angled trapezoid has same bottom side and upper side but different right-angle side and coincides with the central axis of the columnar base body (3); the right-angled trapezoid combinations move axially at a uniform velocity along the central axis of columnar base body (3) simultaneously.

3. The threaded connection pair of claim 2, wherein when the subject right-angled trapezoid combination turns around at a uniform velocity, a distance of the axial movement of subject right-angled trapezoid combination is at least double length of the sum of the right-angle sides of the right-angled trapezoid combination.

4. The threaded connection pair of claim 2, wherein when the subject right-angled trapezoid combination turns around at a uniform velocity, the distance of the axial movement of subject right-angled trapezoid combination is equal to the sum length of the right-angle sides of the right-angled trapezoid combination.

5. The threaded connection pair of claim 2, wherein the left conical surface and the right conical surface of bidirectional cone, namely the first spiral conical surface of taper hole (421) and the second spiral conical plane of taper hole (422) and the internal spiral (5) are all continuous spiral or discontinuous spiral and/or the first spiral conical surface of cone body (721) and the second spiral conical surface of cone body (722), and external spiral (8) are all continuous spiral or discontinuous spiral.

6. The threaded connection pair of claim 1, wherein the internal thread (6) is made of the symmetrical and mutual engaged top face of two taper holes (4), which has the same bottom surface and same top surface but different cone height and its bottom surface is on both ends of the bidirectional taper hole (41); when forming the dumbbell-shaped (94) asymmetric bidirectional taper thread (1), those engaging with the bottom surface of the adjacent bidirectional taper hole (41) respectively and/or or those to be engaged with the bottom surface of the adjacent bidirectional taper hole (41) respectively to present spiral then to become dumbbell-shaped (94) asymmetric bidirectional taper internal thread (6) are included; the subject external thread (9) is made of the symmetrical and mutual engaged top face of two cone bodies (7), which has the same bottom surface and same top surface but different cone height and its bottom surface is on both ends of the bidirectional truncated cone body (71); when forming the dumbbell-shaped (94) asymmetric bidirectional taper thread (1), those engaging with the bottom surface of the adjacent bidirectional truncated cone body (71) respectively and/or or those to be engaged with the bottom surface of the adjacent bidirectional truncated cone body (71) respectively to present spiral then to become dumbbell-shaped (94) asymmetric bidirectional taper external thread (9) are included.

7. The threaded connection pair of claim 1, wherein a large diameter of the external thread (9) is an outer angular shape structure; a small diameter of the external thread (9) is an inner angular shape structure; a large diameter of the internal thread (6) is an inner angular shape structure; a small diameter of the internal thread (6) is an outer angular shape structure; and/or a small diameter of the external thread (9) is a groove (91); a large diameter of the internal thread (6) is a groove (61) structure while both the small and large diameter of the external thread (9) are sharp angle structure; and/or the large diameter of the external thread (9) is plane or arc (92) shaped; the small diameter of the internal thread (6) is plane or arc (62) shaped; while the small diameter of the external thread (9), the large diameter of the internal thread (6) are of sharp angle structure, and/or the small diameter of the external thread (9) is groove (91), the large diameter of the internal thread (6) is groove (61) while the large diameter of the external thread (9) is plane or arc shaped; the small diameter of the internal thread (6) is plane or arc (62) shaped.

8. The threaded connection pair of claim 1, wherein the internal thread (6) and external thread (9) are formed into a thread pair (10) by means of cone pairs constituted by the bidirectional tapered hole (41) and bidirectional truncated cone body (71) coordinating with each other to fix diameter under spiral's guidance; bidirectional truncated cone body (71) and bidirectional tapered hole (41) have clearance; each section of the internal thread (6) contains the corresponding external thread (9) coaxially and by centering and sizing to constitute a pair of sliding bearing; the thread connection pair is constituted by a pair or several pairs of sliding bearing; the internal thread (6) and the external thread (9) bidirectionally joint with each other effectively, that is, bidirectional contact and clasp with each other effectively to contain or be contained thread section; the internal thread (6) taper hole (4) contains external thread (9) cone body (7) bi-directionally and positioning multi-directionally on radial, circumferential, axial and angular etc; each section of the internal thread (6) and the external thread (9) includes one side bidirectional load bearing and/or left and right sides bidirectional load bearing.

9. The threaded connection pair of claim 1, wherein the internal thread (6) and external thread (9) form into a thread pair (10) by means of the coordination of the first spiral conical surface of taper hole (421) and the first spiral conical surface of cone body (721) and the second spiral conical surface of cone body (722) uses the interface as bearing; and under the guidance of spiral, internal cone and external cone self adjust until conical surface of bidirectional taper hole (42) and conical surface of bidirectional truncated cone body hug with each other to achieve the spiral conical surface in one direction bearing and/or the spiral conical surface two directions bearing at the same time and/or until in fix-diameter and self-position contact and/or in fix-diameter interference.

10. The threaded connection pair of claim 1, wherein the columnar base body is solid or hollow; the base body comprises cylinder and/or non-cylinder workpieces and objects which are required to be processed for bidirectional spiral external thread (9) on its outer surface; the cylindrical base body (2) is comprises cylinder body and/or non-cylinder workpieces and objects which are required to be processed for bidirectional spiral internal thread (6) on its inner surface; the outer surface and/or inner surface is cylinder surface and/or cone surface including non-cylinder surface or surface geometry.

11. The threaded connection pair of claim 1, wherein the internal thread (6) and/or external thread (9) comprises single threaded body with incomplete taper geometry, that is, single thread body is incomplete unit body thread.
